(19) United States
(12) Patent Application Publication
(10) Pub. No.: US 2015/0017985 A1
(43) Pub. Date: Jan. 15, 2015

(54) SYSTEMS AND METHODS FOR HANDOFF IN HETEROGENEOUS NETWORKS

(71) Applicant: Samsung Electronics Co., Ltd., Suwon-si (KR)

(72) Inventor: Saeid Safavi, San Diego, CA (US)

(21) Appl. No.: 14/301,203

(22) Filed: Jun. 10, 2014

Related U.S. Application Data
(60) Provisional application No. 61/844,825, filed on Jul. 10, 2013.

(51) Int. Cl. H04W 36/00

(52) U.S. Cl. CPC H04W 36/0083; H04W 36/30
USPC 455/436

(57) ABSTRACT

Computer implemented methods, systems, and computer readable media provided herein may identify contextual information associated with buffer management and data delivery for a handoff between radio access technology points of attachment for a client device. Whether to perform the handoff based on the contextual information and quality of experience (QoE) parameters for an application on the client device may be determined. The handoff may be executed based on the contextual information associated with buffer management and data delivery. An ongoing connection may be reestablished for control and multimedia data flow for the client device.

### PRIORITY

This application claims priority to U.S. Provisional Application No. 61/844,825, filed on Jul. 10, 2013 and titled “Ambient Network Sensing and Handoff for Device Optimization in Heterogeneous Networks”, which is incorporated by reference herein in its entirety.

### FIELD OF THE INVENTION

The present disclosure relates to the field of networking and, in particular, handoffs in heterogeneous networks.

### BACKGROUND

As new client devices (or user devices) and networking technologies evolve, the need for integration of various applications and end-to-end services becomes increasingly important. A growing number of users may require access to continuous services (e.g., audio/video streaming) while moving among different points of attachment (PoAs) to the network (e.g., internet, cellular, etc.) with different connectivity technologies. In addition, different access technologies (e.g. WLAN, WiFi Direct, sensor networks, Bluetooth, 60 GHz, etc.) are increasingly being integrated into client devices to enhance user experience and address bandwidth issues, capacity, and coverage challenges. The multitude of connectivity technologies gives rise to heterogeneous networks where networks of various architectures and topologies are superpositioned or overlaid, ranging from pico-cellular systems to macro-cellular systems covering a variety of user applications and services. The new trends relating to wireless access technologies, networking, and content delivery create a very challenging paradigm. Improvements in the art are desired to address this paradigm.

### SUMMARY

An embodiment of a system including at least a processor and a memory. The memory storing instructions configured to instruct the processor to identify contextual information associated with buffer management and data delivery for a handoff between radio access technology points of attachment for a client device. Determine whether to perform the handoff based on the contextual information and quality of experience (QoE) parameters for an application on the client device. Execute the handoff based on the contextual information associated with buffer management and data delivery. Also, the ongoing connection may be reestablished for control and multimedia data flow for the client device.

An embodiment of a method may include identifying contextual information associated with buffer management and data delivery for a handoff between radio access technology points of attachment for a client device. Determining whether to perform the handoff based on the contextual information and quality of experience (QoE) parameters for an application on the client device. Executing the handoff based on the contextual information associated with buffer management and data delivery. Reestablishing an ongoing connection for control and multimedia data flow for the client device.

An embodiment of a computer readable medium comprising instructions for identifying contextual information associated with buffer management and data delivery for a handoff between radio access technology points of attachment for a client device; determining whether to perform the handoff based on the contextual information and quality of experience (QoE) parameters for an application on the client device; executing the handoff based on the contextual information associated with buffer management and data delivery; reestablishing an ongoing connection for control and multimedia data flow for the client device.

Many other features and embodiments of the invention will be apparent from the accompanying drawings and from the following detailed description.

### BRIEF DESCRIPTION OF THE DRAWINGS

FIG. 1 illustrates a diagram of an example system for performing a device-centric context-aware handoff, according to certain embodiments.

FIG. 2 illustrates a block diagram of an example high level architecture of a system for ambient network sensing system, according to certain embodiments.

FIG. 3 illustrates a block diagram of an example CAHE module and a context manager (CM) module, according to certain embodiments.

FIG. 4A illustrates a block diagram of an example client device including a CAHE module, according to certain embodiments.

FIG. 4B illustrates a block diagram of an example proxy device including a CAHE module, according to certain embodiments

FIG. 5 illustrates a block diagram of an example system including a fuzzy logic inference module (or engine), according to certain embodiments.

FIG. 6 illustrates a block diagram of an example context manager (CM) module communicatively coupled to a CAHE module, according to certain embodiments.

FIG. 7 illustrates a flowchart of an example client side handover for a device-proxy configuration, according to certain embodiments.

FIG. 8 illustrates a flowchart for an example method of a proxy side handover for a device-proxy configuration, according to certain embodiments.

FIG. 9 illustrates a diagram of an example Bluetooth-WiFi handoff for a client device in a heterogeneous network, according to certain embodiments.

FIG. 10 illustrates an example of a computer system, according to certain embodiments.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles of the invention described herein.

### DETAILED DESCRIPTION

For mobile device manufacturers, a very important byproduct of integration of various applications and end-to-end services in a heterogeneous environment is a need for more components and processing power while maintaining a tight device power budget. On the other hand, as cellular networks evolve to support heterogeneous architectures with ubiquitous connectivity, a high degree of adaptation, awareness, and flexibility may be required, particularly in radio access. At the same time, however, by moving from traditional concepts of macro-cell towards small cells with a number of femto cell overlays, operator control and management over access resources are becoming increasingly out of reach, particularly from an interference control perspective. This may be mainly driven by an unpredictable number and position of femto access points (FAPs), where interference management cannot be further handled by an operator through traditional network planning and optimization methodologies, leading to the challenge of spectrum management.

Network awareness may be deployed in various types of wired and wireless networks, including application aware networks and network aware routing. Intelligent sharing of a radio spectrum may include handoff or offload of traffic based on an inherent diversity in heterogeneous wireless networks. The requirements in terms of spectrum resources or wireless channel conditions may vary spatially and temporally for each radio access technology (RAT). This variation in diversity may be used to flexibly assign resources to RATs that require them at each time and location. In joint radio resource management (JRRM), an upper layer may be in charge of managing a sharing of spectrum between multiple RATs in a heterogeneous network.

From an operator's perspective, the concept of an integrated small cell may be a significant component of the spectrum management challenge. This challenge may be further intensified by an ever growing bandwidth crunch from increased user consumption. Future operator networks may demand a tightly integrated spectrum access solution capable of very advanced dynamic spectrum access policies across various spectra. The diversity of the spectra may range from TV white spaces (TWS) bands in the sub-GHz band all the way to millimeter wave in the 60 GHz range, for example. The spectra may also include all traditional access bands used by cellular and hotspot operators.

In certain embodiments, systems and methods are provided that involve a device-centric technology based on a smart context-aware connection control and management module (or engine). The systems and methods may automate spectrum access so that users do not have to think about network access issues, such as what cellular operator to use or what network connection (e.g., WiFi Hotspot, Bluetooth, WiFi Direct) to use. The systems and methods may include a device-centric policy control and management architecture that is application aware, policy oriented, and influenced by user preferences. The user preferences may include, for instance, application priorities and cost preferences, such as how much a user is willing to spend on an access right. The device-centric access selection process may include analyzing available connectivity options along with access policies provided by an operator, optimizing device performance, and allocating an appropriate amount of bandwidth for an application. In certain embodiments, local policies may provide support for features that may take advantage of multi-network scenarios, such as IP flow mobility and bandwidth aggregation.

In certain embodiments, seamless vertical handoffs performed with multiple context aware middleware on client devices and network nodes may be implemented with a proxy device (also referred to herein as a “context adaptive proxy”). The context adaptive proxy may be implemented to ensure seamless connectivity and to maintain user quality of service (QoS) in a heterogeneous network. In this way, performance of client devices may be optimized while seamless connectivity is provided. Furthermore, service provisioning may be dynamically personalized to characteristics of a client device and to its operational environment.

In certain embodiments, systems and methods are provided that take advantage of existing enhancements on device design and standards protocols towards implementation of a seamless vertical handover platform that tightly integrates context awareness to the handoff management and execution. In certain embodiments, systems and methods are provided that maintain or enhance user experience during intra and inter technology switching, also known as horizontal and vertical handoff (or handover), by ensuring seamlessness of application and session connectivity.

In certain embodiments, a device-proxy middleware architecture is provided, also referred to herein as context aware network middleware platform (CANMP). The CANMP allows for seamless handoff execution by a device, or handoff execution assisted by a proxy device. The CANMP may, for example, incorporate contextual information monitoring, device state modeling, handoff prediction, and handoff analysis to assist in the seamless handoff.

The inherent diversity across multiple radio resources and access technologies may be used towards an intelligent intra and inter technology switching, even when the user is not moving. Combined with conventional handoff, which may be triggered by user movements, such a smart handoff may significantly enhance performance and efficiency both at a device level and a network level. For example, in addition to a traditional horizontal handoff mechanism in a specific radio access network (RAN) (e.g., between cells or APs), a user may switch between different RAN networks with a multi-interface client device (or terminal). Example multi-interface client devices may include, but are not limited to, personal computers, laptops, smartphones, tablets, etc. Vertical handoff (VHO) may be triggered by several factors such as user movement, radio channel fading, interference and changes in a device or infrastructure capabilities, etc. In this way, switching on-going connections from one radio access network technology (RATs) to another may be provided. Since VHO involves changing a point of attachment to a network with a different technology, various layers (e.g., link, network and transport layers) may be affected.

Spectrum sharing may be performed among different RATs to enhance bandwidth utilization. This may be driven by bandwidth limits and demand for service providers to offer more than one RAT to its users (e.g. LTE, HSPA, WiFi, WiMAX) in a specific area. Hence, to provide coverage to all users, different RATs may be deployed. As smart phones and tablets are capable of several access interfaces, an operator may have the flexibility of deciding to which RAT a client device should attach in order to maximize spectrum utilization while providing a required QoS. Requirements in terms of spectrum resources may vary spatially and temporally for each RAT. This variation and diversity may be used to flexibly assign resources to RATs that require them at each time and location.

Bandwidth allocation within a context of JRRM may require VHO. In JRRM, an upper layer may be in charge of managing a sharing of spectrum between multiple RATs. In many instances, a level of granularity at which an ordinary scheduler for local radio resource management may work will be smaller than the JRRM. For example, LTE and HSPA may define their scheduling decisions each millisecond, so the JRRM may work in granularity of seconds or minutes. Although this type of sharing may occur in 3G and 4G wireless technologies, the state of the art in 4G (e.g., LTE-Advanced (LTE-A)) adds a new level of complexity and degree of freedom by allowing the use of carrier aggregation. Offload may also require vertical handoff. In particular, within a context of traffic offload between LTE and WiFi, 3GGP release 8 (LTE) and release 10 (LTE-A), specific protocols may be defined based on dual stack mobile IP (DSMIP) for seamless traffic handoff between LTE and WiFi through a home agent (HA) at a service provider gateway.

Smaller footprints of FAPs or WLAN/WPAN networks, which are out of an operator's control, may present issues. In terms of inter-operator policy control and coordination, there may be little consistency between the mechanisms used by WiFi operators and those used by cellular operators to control VHO and network policies. For example, several mechanisms such as network discovery and selection, user authentication and authorization, traffic prioritization, roaming capabilities, and QoS may have little consistency between WAN architectures, such as 3G/4G cellular and WiFi based on Hotspot 2.0. As a result, user experience of heterogeneous networks may be highly dependent on client device behavior, and hence on the client device vendor. In certain embodiments, device behavior may be controlled by a device connection manager which tries to balance between user preferences, different types of network policies, and other information that may be discovered about available access networks to make a correct and automatic connectivity decision on behalf of a user.

IEEE standards may include IEEE 802.21 as a new Media Independent Handover (MIH) standard to facilitate vertical handover challenges. IEEE 802.21 provides a homogeneous function interface between heterogeneous network technologies and offers standard handover services between lower and higher layers. The role of 802.21 may be to serve as a facilitating service for handovers and to maximize an efficiency of such handovers by providing appropriate link layer intelligence and network information. Media Independent Handover Function (MIHF) may be able to encapsulate different underlying network technologies (e.g., 802.3, 802.11, 802.16, 3GPP, and 3GPP2) to upper layers.

The MIHF entity may be considered as a layer 2-layer 3 interface with a protocol defined by the IEEE 802.21 standard, which establishes messages exchanged between peer MIH entities for handover. In this way, a common message payload may be offered across different media (e.g., 802.3, 802.11, 802.16, cellular, etc.). For lower layers, the standard refers to technology dependent components. For upper layers, the standard refers to the requesting modules. The lower layers may be accessed by different functions to retrieve information to detect, prepare and execute a VHO, while the upper layers may demand the information. Therefore, the latter may also be referred to as Media Independent Handover User (MIHU).

The MIHF may offer a service access point (SAP) to both lower layers and upper layers in order to exchange service messages. The MIHF may provide abstracted services to higher layers. The service primitives defined by this interface may be based on technology-specific protocol entities of different access networks. The MIHF may communicate with the lower layers of the mobility-management protocol. However, the MIH-based 802.21 protocol is not complete and does not provide support of session continuity in VHO through handoff execution. It may be primarily concerned with the mechanism and signaling facilitating measurements for initiation of VHO, without providing support of network selection algorithms and actual handoff execution and its management.

In certain embodiments, systems and methods are provided that use a device-proxy architecture to perform a seamless handover execution in response to a handover decision. The handover decision may be based on contextual information available to a device, network, or both. Based on collected (or gathered) information, a handover decision decides when and where to trigger a handover. The “when” decision may refer to an instant in time to make an optimal handover. The “where” decision may refer to selecting an optimal (e.g., best) network to fulfill requirements for switching. Example algorithms that may be used to evaluate cross-layer multi-parameters include techniques such as fuzzy logic, neural networks, pattern recognition, etc. In addition to performing the handover, a handover execution phase may include ensuring a smooth session transition process. In certain embodiments, a handover may include cooperation with control signaling and IP management protocols in order to perform the VHO.

Contextual information may facilitate successful hand off execution. An accurate VHO, for instance, may take into account contextual information such as service continuity, network discovery, network selection, security, a device's power-management and QoS issues. In certain embodiments, QoS may be a primary factor. In a homogeneous network environment, deciding “when” to handover usually may depend on RSS values for instance, while the “where” may not be an issue since the same networking technology applies for a horizontal handover.

In certain embodiments, contextual information may be collected from different sources. For example, the mobile device may survey the surrounding networks in order to discover services, data rates, and power consumption. In some instances, to complement the information gathered through scanning, networks may also advertise their supported services and QoS parameters while the device information (e.g., speed, battery status, features, etc.) is collected. Information concerning user preferences may also be a relevant element to the decision making process, which may be primarily due to its impact on the end-user's satisfaction.

In certain embodiments, middleware may perform context-aware handoff management to best suit a desired purpose. For example, a certain device-centric cost function may be optimized through execution of transparent handoffs while avoiding service interruptions. A more complete awareness of the environment, including the device state, and the handoff process may provide for more effective and efficient optimization of device performance and service continuity in heterogeneous environments.

Context awareness may relate to visibility of characteristics describing device interactions with a specific RAN technology, application of interest, and service execution environments. In this way, for instance, management operations may adapt service provisioning to current device states and network conditions. In certain embodiments, context awareness may relate to full visibility of all characteristics describing interactions of a current application running on a specific device with a specific radio access network connectivity and service execution environments.

In certain embodiments, systems and methods provided herein may assist client devices to transition to a more resource efficient state by using the visibility of available wireless connections and their handoff characteristics that may lead to device performance enhancements. A “device state” may be determined (or defined) in a manner that accurately reflects one or more device metrics of interest. For example, the device metrics may include performance metrics, such as power, speed, delay, processor load, etc. In certain embodiments, contextual information may include operator preferences, user preferences, or user behaviors.

In certain embodiments, middleware constituting an intelligent client may be provided on the client device. The middleware may enable a client device (e.g., smartphone, tablet, etc.) to make intelligent network selection and traffic management decisions between available RAN technologies, such as Bluetooth, WiFi, 3G, and LTE networks. In this way, the middleware may provide beyond what is provided by Access Network Discovery and Selection Function (ANDSF) and Hotspot 2.0 (HS2.0), for instance. The capabilities of these networking alternatives may be provided to the middleware in terms of “profiles”. Profiles may, for instance, generally constitute a collection of handoff related parameters per network. The middleware may also provide other operator and service related support functionalities, such as intelligent management of application specific traffic and operator use cases (e.g., WiFi offload) while maintaining a QoS and a quality of experience (QoE) for users on any network.

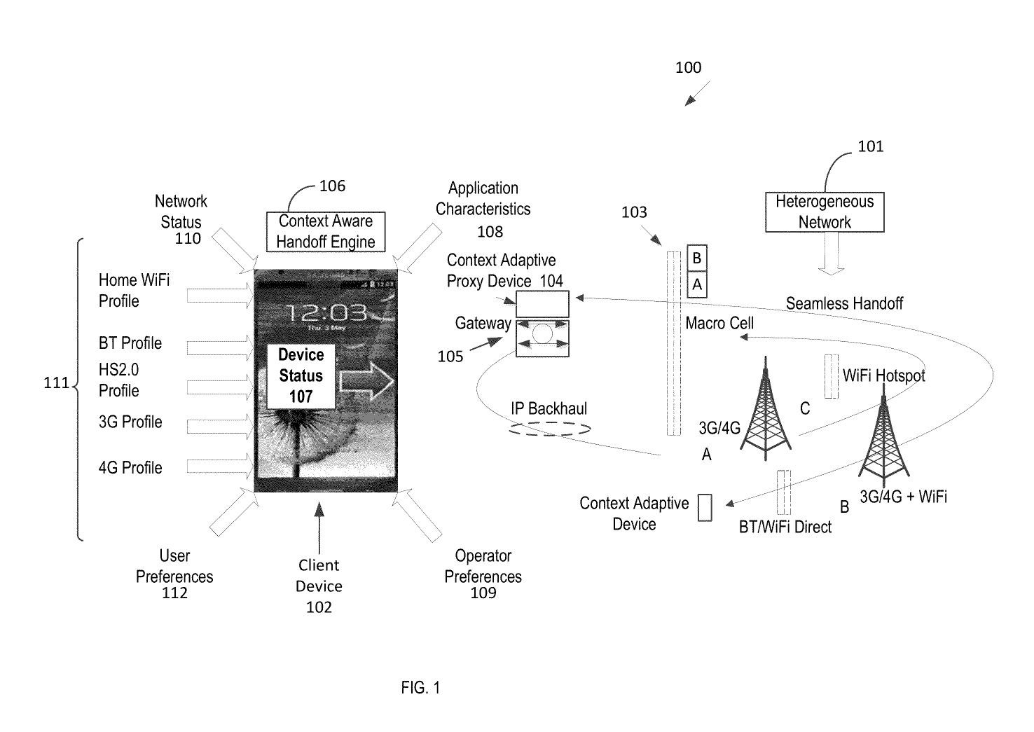

FIG. 1 illustrates a diagram of an example system 100 for performing a device-centric context-aware handoff, according to certain embodiments. The system 100 may include a heterogeneous network 101 and a client device 102, such as a mobile (or portable) device. Example client devices may include smartphones, tablets, laptops, etc. The heterogeneous network 101 may include a macro cell tower 103 which hosts a colocation of base station devices from two operators, A and B. Other small cell architectures supporting “3G/4G” and “3G/4G+WiFi” may enhance capacity and coverage holes for operators A and B, respectively. In addition, a “WiFi Hotspot” may be operated by a third operator C. A user home network capable of supporting WPAN connectivity with Bluetooth plus WiFi direct may be situated within the footprint of the macro cells A and B. The example networks and configuration are not intended to be limiting. Many different combinations of alternative connectivity may be available to the user depending on location, device characteristics, and network conditions. In some instances, one or more connectivities may not be manageable by the operators A, B, or C.

The system 100 may also include middleware having two ends operating in a client-proxy setup. A client 106 may reside on the client device 102, while a proxy 104 may be installed on the infrastructure side of the heterogeneous network 101. In certain embodiments, the proxy 104 may be installed on a service gateway 105 acting at a session layer as a “session proxy”.

The client device 102 may be a context adaptive device equipped with the client 106 of the middleware. The client 106 may function as a context-aware handoff engine. The term context-aware handoff engine may also be referred to herein as a “CAHE module” or “CAHE”. The task of the CAHE module may be to monitor handoff opportunities that may lead to a better “device state”, given current collected context information. The CAHE module may also have control over the ordinary handoff events, which may be triggered by user movements. The ordinary handoff events may include, for example, the imminent horizontal handoff which happens when the client device moves from cell coverage of one cell to another within the same network. The CAHE module may, for instance, be a decision function based on a weighted requirement and contextual information, such as maximum power consumption, application, and user preferences. Implementing context-aware handoffs with service continuity management may involve many technological details extending across different layers affected by the underlying executing platform.

In certain embodiments, applications may only have to declare their service requirements to the middleware infrastructure, such as through session initiation protocol (SIP) or IMS signaling. In this way, the handoff process may be simplified. For example, the task of using the device states and context awareness may be performed only within the middleware. The middleware on the client device 102 and proxy 104 may take over the handoff responsibility as well as the specific management operations. Systems and methods are provided in the present disclosure for prediction and triggering of handoff events (e.g., handoff awareness), management of service quality requirements and handoff-related quality degradations (e.g., QoS awareness), and solutions for visibility into network topology and local resource availability (e.g., location awareness).

Example categories of contextual information shown in FIG. 1 may include device level contextual information (e.g., device status 107), application level contextual information (e.g., application characteristics 108), network level contextual information (e.g., operator preferences 109, network status 110 and RAT profiles 111), and user level contextual information (e.g., user preferences 112). The CAHE module may include a device state and handoff recommendation module which may process the contextual information to optimize the device state based on available networks where an existing session may be run.

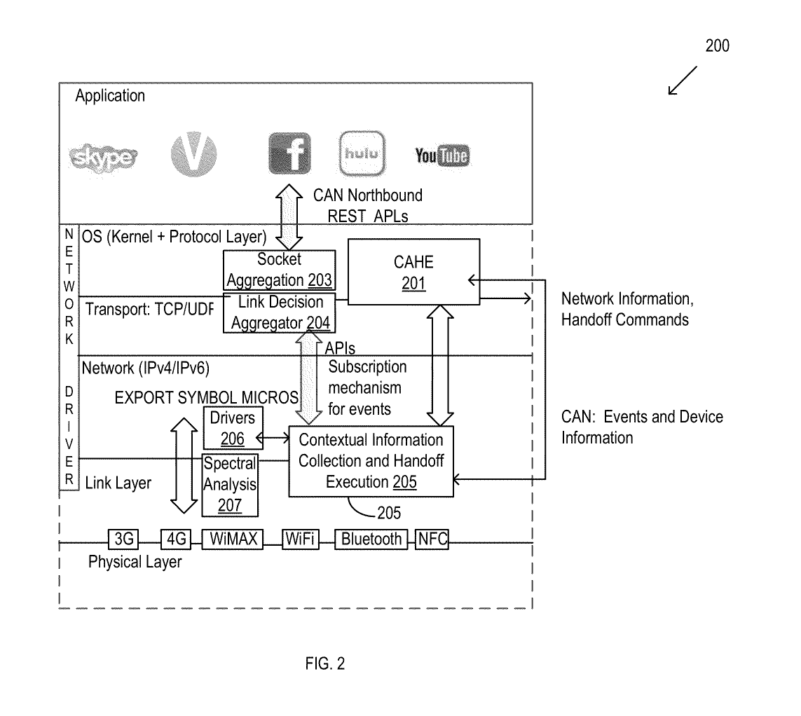

FIG. 2 illustrates a block diagram of an example high level architecture of a system 200 for ambient network sensing system, according to certain embodiments. The system 200 includes a middleware platform that is shown with respect to a protocol stack. The system 200 includes a context aware handoff engine (CAHE) module 201 that provides handoff decision and management capabilities in a manner that is seamless, QoS and QoE aware, and with complete context transfer and service rebind.

A socket aggregation module 203 and a link decision aggregator module 204 may operate in the upper layers with the CAHE module 201. Communication with a contextual information collection and handoff execution module 205 may be enabled through APIs. The handoff execution may be MIH function based. The contextual information collection and handoff execution module 205 may be implemented as two separate modules in other embodiments. The contextual information collection and handoff execution module 205 may operate in the lower layers, such as the data link layer and the network layer, in conjunction with drivers 206 and a spectral analysis module 207. The CAHE module 201 may receive network information, events, and device information from the contextual information collection and handoff execution module 205 while providing the contextual information collection and handoff execution module 205 with handoff commands.

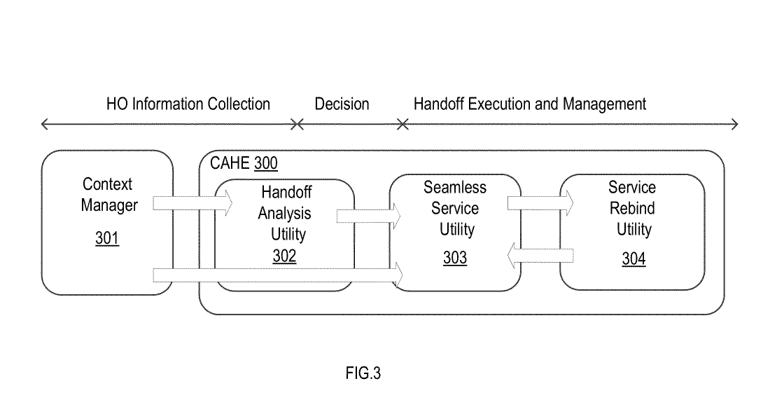

FIG. 3 illustrates an example block diagram of a CAHE module 300 and a context manager (CM) module 301, according to certain embodiments. The CAHE module 300 and the CM module 301 may perform various functions for a contextual information collection process, a decision process, and a handoff execution and management process. The CM module 301 may manage and provide device and network contextual information collection for the CAHE module 300. The contextual information collection may implement, for example, the 802.21 protocol and MIHF as described in the 802.21 standards.

The CAHE module 300 may provide functionality for the contextual information collection process, the decision process, and the handoff execution and management process. The CAHE module 300 may include a handoff analysis utility module 302, a seamless service utility module 303, and a service rebind utility module 304. The handoff analysis utility module 302 may perform handoff analysis and predication via full visibility into the contextual information, as well as, handoff procedures and parameters. This may involve, for example, monitoring technology dependent handoff processes at a data link layer. The seamless service utility module 303 may perform an effective handoff management strategy to ensure compliance with application level and user service requirements through control of flow provisioning to combat handoff impairment effects. Example handoff impairment effects may include packet loss, delay, delay variation, jitter, etc., which may result in degradation of QoS. The service rebind utility module 304 may perform dynamic reconnection of clients to resources and service components at a target RAN. This may include transferring contextual information to the target RAN for client reconfiguration operation (e.g., client readdressing, AAA, QoS, location, etc.) and reconnecting all client components to locally available resources.

In certain embodiments, a pluggable or modular architecture may be implemented to build a generic platform. The pluggable architecture may permit usage and addition of different application-level rebinding protocols and re-addressing techniques by implementing extension modules.

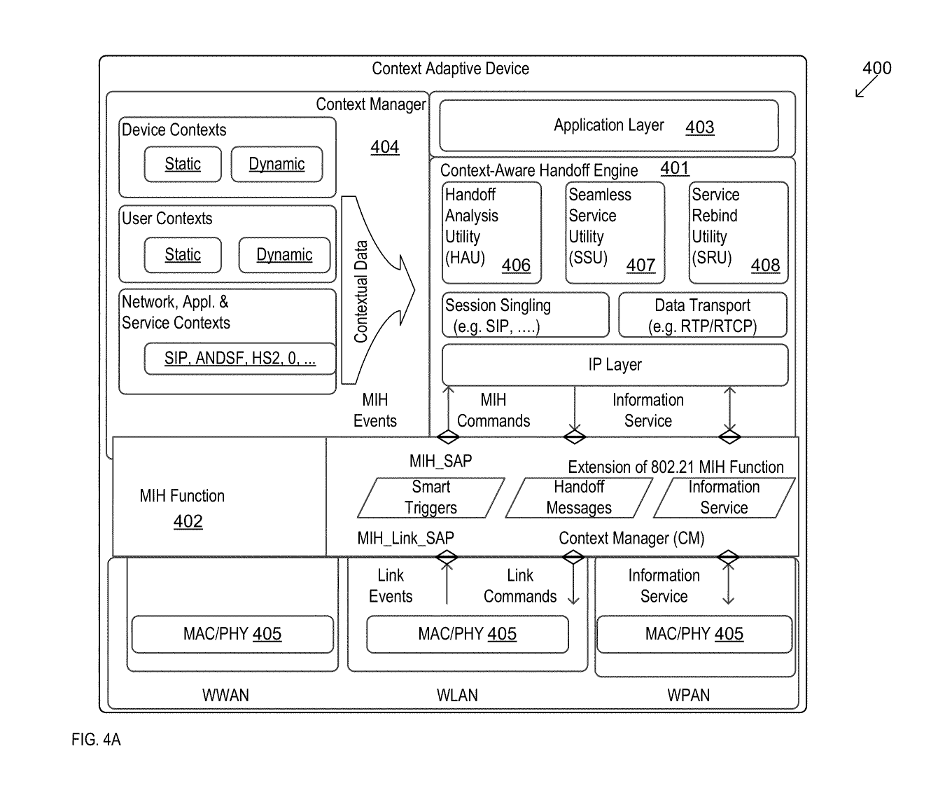

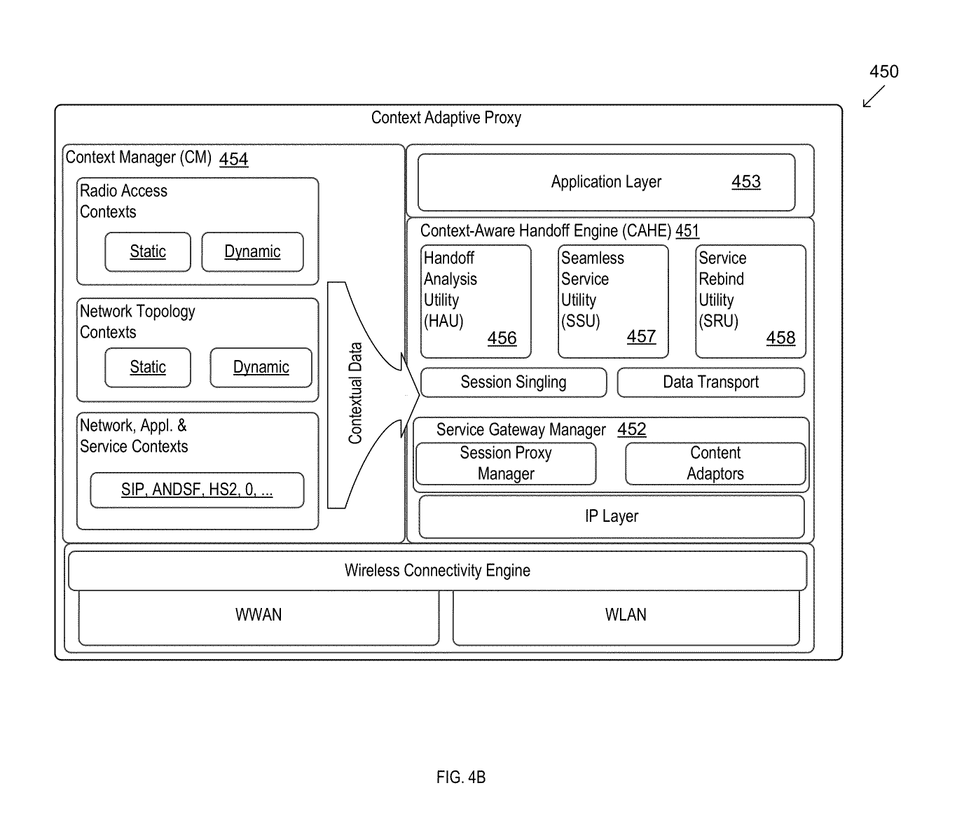

FIG. 4A illustrates a block diagram of an example client device 400 including a CAHE module 401, according to certain embodiments. The client device 400 may also include a MIHF module 402, an application layer 403, a context manager (CM) module 404, and media access control (MAC) and physical layer components 405. In certain embodiments, the client device 400 may be a mobile device, such as a smartphone, laptop, tablet PC, etc. FIG. 4B illustrates a block diagram of an example proxy device 450 including a CAHE module 451, according to certain embodiments. In certain embodiments, the proxy device 450 may be a network edge device or service gateway within an ecosystem with a client device, such as the client device 400. The client device 400 may operate in conjunction with the proxy device 450 to perform handoffs within heterogeneous networks. The proxy device 450 may also include an application layer 453 and a CM module 454.

On the client device 400, the CAHE module 401 may communicate with the application layer 403 and the CM module 404. The CAHE module 401 may be implemented as middleware on the client device 400. The CM module 404 may collect relevant contextual information and communicate it to the CAHE module 401 for analysis and handoff management. The contextual information may vary between the client device 400 and the proxy device 450. For example, the contextual information may include device states, user preferences, application and service data, characteristics of available networks, etc.

The CAHE module 401 may include a handoff analysis utility (HAU) module 406, a seamless service utility (SSU) module 407, and a service rebinding utility (SRU) module 408 to perform three distinctive management utilities for analysis, QoS management, and enabling configurability of an execution environment, respectively. The HAU module 406 may estimate (or predict) a handoff event based on a device state. The handoff event may be associated with a need for (or benefit of having) a handoff. The estimation of the handoff event may also be based on user movement. For instance, a handoff event may be initiated as a previous network becomes out of reach. Device state attributes (e.g. power, speed, etc.) and handoff triggering measurements (e.g., received signal strength indicator (RSSI)) may be communicated to the HAU module 406 by the CM module 404. The HAU module 406 may ensure proactive prediction and analysis of handoff events (e.g., horizontal or vertical), whether initiated for better device state or required by user movement. When a handoff is triggered by a user moving away from a serving cell, the device state may still decide between potential target networks if alternative RANs are available.

The SSU module 407 may support an adaptive aspect of handoff by utilizing QoS. The SSU module 407 may utilize an application layer visibility of QoS content-related handoff and application level service requirements from an operator. This may be used to decide on a type of handoff, such as soft handoff versus hard handoff, co-located multi-RAT handoff versus inter-cell handoff, etc.

The SRU module 408 may support configurability during a handoff by adjusting service execution and system requirements while trying to improve a device state, such as power consumption. Various rebinding tasks may be included, such as transfer of a contextual information to a new node, admission control tasks such as re-authentication and readdressing, etc.

On the proxy device 450, the CAHE module 451 (e.g., middleware) communicates with the application layer 453 and the CM module 454. The context manager module 454 may collect relevant contextual information and communicate it to the CAHE module 451 for analysis and handoff management. The contextual information may vary between the client device and the proxy. For example, the contextual information may include device states, user preferences, application and service data, characteristics of available networks, etc.

The CAHE module 451 may include a HAU module 456, a SSU module 457, and a SRU module 458. The functionality of the HAU module 456, the SSU module 457, and the SRU module 458 on the proxy device 450 may differ from the functionality of the HAU module 406, the SSU module 407, and the SRU module 408 on the client device 400, respectively. In some instances, the functionality of the HAU module 456, the SSU module 457, and the SRU module 458 on the proxy device 450 may be similar to the functionality of the HAU module 406, the SSU module 407, and the SRU module 408 on the client device 400, respectively.

On the client device 400, the HAU module 406 may collect monitored information on available radio access channels (e.g., RSSI, interference signatures, spectrum occupancy) and device state. A handoff event may be initiated based on the contextual information. Based on the monitored data, the HAU module 406 may analyze the handoff state and either recommend or predict a handoff event. Such a recommendation may, for example, be triggered by spotting alternative RANs that may lead to better device state and link performance. Predictions may be an outcome of an inevitable handoff scenario (e.g., due to user movements) when only one candidate network is available. When more than one network is available, the HAU module 406 may recommend an optimal network to connect to during user movements and according to the device state.

On the proxy device 450, the HAU module 456 may receive handoff event data from the client device 400, whether recommended or predicted. The HAU module 456 may process the received handoff event data, if needed, and communicate it to the SSU module 457 on the proxy device 450, which is in charge of execution and management of the handoff. The received handoff event data passed from the HAU module 456 to the SSU module 457 may include various attributes such as target access points (APs) or base station (BS) information (e.g. its MAC address), the type of handoff (e.g., vertical or horizontal; soft or hard; micro, macro, or global), and some information regarding a minimum time that a handoff could or will happen. Other useful handoff parameters, such as data link handoff latency, may also be estimated by the HAU module 406 and communicated to the SSU module 457 through the HAU module 456. The SSU module 457 may serve as a “handoff brain” by controlling the overall handoff process. For example, the SSU module 457 may communicate handoff strategies to the SRU module 458 for rebinding actions. The SRU module 458 may, for instance, provide appropriate client readdressing and component rebinding as required by a handoff decided in the SSU module 457.

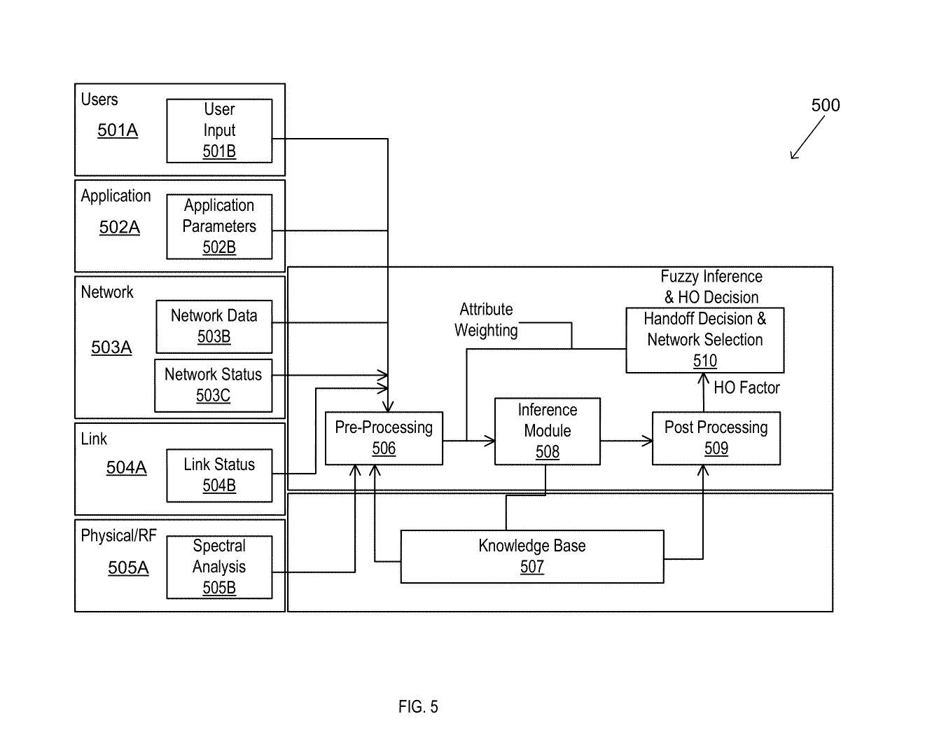

FIG. 5 illustrates an example block diagram of a system 500 including a fuzzy logic inference module (or engine) that may be used to perform handoff analysis and prediction with full visibility into contextual information and hand-off parameters, according to certain embodiments. The system 500 may include a pre-processing module 506 that receives contextual information obtained from various layers and user input. For example, the contextual information may include user input 501B from users 501A, application parameters 502B from an application layer 502A, network data 503B and a network status 503C from a network layer 503A, a link status 504B from a link layer 504A, and a spectral analysis data 405B from a physical (e.g., RF) layer 505A.

The pre-processing module 506 may incorporate input from a knowledge base module 507. The knowledge base module 507 may include, for example, rule based fuzzy logic including “If-Then” rules and a related database. The output of the pre-processing module 506 may then be provided to an inference engine module 508, which may also receive input from the knowledge base 507. The inference engine module 508 may use input parameters to determine whether a vertical handoff should be initiated. The input parameters may include, for example, data rate, RSSI, coverage area of a network and perceived QoS, and device related parameters such as power consumption. For example, the inference engine module 508 may apply a set of fuzzy “If-Then” rules to obtain fuzzy decision sets. The output of the inference engine module 508 may be provided to a post processing module 509 along with input from the knowledge base 507. The post processing module 509 may provide a handover (HO) factor to a handoff decision and network selection module 510. For example, fuzzy decision sets may be aggregated into a single fuzzy set and passed to a defuzzifier to be converted into a precise quantity (e.g., a handoff factor) which may determine whether a handoff is necessary. The handoff decision and network selection module 510 may also incorporate an attribute weighting which is applied to the output from the pre-processing module 506.

The system 500 may also incorporate QoS provision techniques. For example, the system 500 may take into account various parameters, including smart scanning or spectral analysis of the physical (e.g., RF) layer 505A, proactive handoff prediction, resource management, and controllable data communication and scanning. In one embodiment, the QoS provision techniques may maintain delay or jitter. For example, delay or jitter may be maintained below a threshold value of 50 milliseconds. The threshold value may vary in other embodiments.

In certain embodiments, a multiple attribute objective or fitness function, referred to herein as network selection (NS) function, may be used for network selection in a handoff decision. The NS function may provide a value or measure reflecting an efficiency of utilizing radio resources and an improvement in QoS gained by handing off to a specific network. The NS may be determined (or defined) for some or all alternative networks that cover a user area of service. In certain embodiments, a network that provides a highest NS value may be selected as an optimal (e.g., best) network for handoff from a current access network. The selection may be made according to client device conditions, network conditions, service and application requirements, cost of service, and user preferences. The HO factor may be used as an input to the NS function. In an embodiment, the NS function may include a type of the Multi-Criteria Decision Making (MCDM) algorithm.

In certain embodiments, metrics and parameters may be combined to build an optimal cross-layer handover algorithm. A decision algorithm may include, for example, a Markov Decision Process (MDP) with link reward and signaling overhead functions. Another embodiment may be based on a Weighted Markov Chain (WMC). In one embodiment, a Markovian solution may be based on rank aggregation.

In certain embodiments, NS may comprise parameter selection algorithms, parameter processing algorithms, or parameter aggregation algorithms. The parameter selection algorithms may utilize contextual information to generate information to perform an accurate network selection decision. For example, any changes in a mobile and network context may trigger events and processes which may be used to make a VHO decision. Depending on the number of parameters selected for processing, various algorithms may range in complexity. In one embodiment, network services, user preferences, device specifications, and time may be considered. Once the information is collected, a QoS predictor may perform a path prediction to ensure end-to-end QoS. For example, information collected and predicted may be evaluated under an Analytic Hierarchy Process (AHP) algorithm, in which the decision problem may be divided into sub-problems. Other multiple criteria decision making algorithms may also be implemented in other embodiments.

The functions used for parameter processing algorithms may vary from largely mathematical to computational algorithms. For example, an example parameter processing algorithm may be implemented using a Markov decision approach based on rank aggregation (e.g., where a top weighted network may be selected) or based on neural or fuzzy logic.

Parameter aggregation algorithms may account for diverse metrics and parameters used to evaluate a most optimal candidate network. For example, Multiple Criteria Decision Making (MCDM) algorithms may be implemented to aggregate processed parameters. Examples algorithms may include, but are not limited to, Grey Relational Analysis (GRA), Technique for Order Preference by Similarity to Ideal Solution (TOPSIS), and Simple Additive Weighting (SAW). For instance, both GRA and TOPSIS may include comparison to an ideal solution and selection of a network nearest to the ideal solution. In another instance, SAW may be implemented and may include scoring each alternative by adding attributes weighted by their weights. In certain embodiments, an HO factor, which may be used for seamless service (e.g., by the SSU modules 407,457), may come from another source which utilizes other techniques for determining when the handover should be carried out.

In FIGS. 4A and 4B, the SSU modules 407,457 may serve as a “handoff brain” by controlling the overall handoff process. For example, the SSU modules 407,457 may be in constant communication with associated entities (e.g., on the device side or the proxy side) to collect handoff analysis data, which they may use to choose an entity as a target RAN AP (or BS). The SSU modules 407,457 may also communicate handoff strategies to the SRU modules 408,458 for rebinding actions.

On the client device 400, the SSU module 407 may analyze contextual information pertaining to application related profiles (e.g. device characteristics and capabilities, user RAN preferences, etc.); service related information (e.g., service level specifications); application QoS parameters (e.g., maximum allowed jitter, delay, packet loss); etc. In this way, the SSU module 407 may communicate relevant information for buffer management and data delivery to the SSU module 457.

On the proxy device 450 side, the SSU module 457 may control a final decision on handoff and may be in communication with a service continuity utility of the service gateway it resides on via the service gateway manager 452. In this way, “network topology information”, such as how APs or BSs are connected to a core network and the related control mechanism for instance, may be collected from a context store. Additional information such as handoff analysis data, attributes received from the corresponding HAU module, and client profiles (e.g., service level specifications and data delivery information from the SSU module 407) may also be included to finalize, manage, and execute the handoff decision.

Once a decision on a handoff is finalized, the SSU module 457 may control the entire data flow transmission at a network edge (e.g., the last hop connecting wired to wireless part of the network) through appropriate management of memory resources at its corresponding service gateway. Final decisions, such as soft versus hard handoff, may be made at this stage depending on an availability of resources that are observed by the SSU module 457.

In certain embodiments, a VHO may be completely performed by the client device 400 without an accompany proxy device (e.g., the proxy device 450). In such an implementation, the SSU module 407 on the client device 400 may perform the associated actions for maintaining QoS, such as buffering and retransmission (e.g., media delivery buffer management). The SSU module 407 may have access to relevant information for buffer management and data delivery and would not need to communicate it to a SSU module on a proxy device. In this implementation, the SSU module 407 on the client device 400 may control the final decision of the handoff, along with the decision on soft versus hard handoff, etc.

The SRU modules 408,458 may provide appropriate client readdressing and component rebinding as required by a handoff decided in one or both of the SSU modules 407,457. The SRU modules 408,458 may provide reestablishment of data and control flows, which may be relevant in macro (or inter-subnet) and global (or inter-domain) handoffs. In macro handoffs, the client device 400 may switch between two APs or BSs that are topologically attached to different IP subnets. As such, a network layer handoff may be initiated, resulting in IP address changes. The SRU modules 408,458 may provide reestablishment of ongoing connections for control and multimedia data flows which were interrupted by macro handoffs. An ongoing connection may refer, for instance, to a session that needs to be maintained during vertical or horizontal handover. For example, buffers may be used to absorb hiccups (or errors) in communication during handover. On the other hand, global handoffs may relate to switching between two RANs that are connected to different domains, which may require a new AAA session (e.g., re-authorization, re-authentication, and re-accounting for the client) in addition to an IP address change. In this regard, client node readdressing and the AAA operation may enable completion of reconfiguration operations before a handoff is fully executed. In global handoffs, the SRU modules 408, 458 may perform (or coordinate) service rebind (e.g., associated with connecting a device to a target RAN's resources and service components) and contextual rebind (e.g., associated with transfer of context information to a target device).

Both the SRU modules 408, 458 on the client device 400 and the proxy device 450, respectively, may utilize various techniques that operators use for service rebinding and context transfer. In addition, extra contextual data may be added by the SRU modules 408, 458 when a context definition from an operator is incomplete. For example, 4G location awareness may consider context rebinding and the context definition adapted may be incomplete in certain instances or focused on AAA aspects. In such situations, the SRU modules 408, 458 may add or receive extra contextual data (e.g., handoff specific context, QoS information, etc.). Such information may come from the corresponding HAU or SSU modules. In certain embodiments, service rebinding may be performed automatically and may be transparent to the user. In this way, the user may continue with an uninterrupted user experience on the device.

With regard to MIHF in general, the current IEEE 802.21 standard has defined a MIH mechanism that helps to optimize a handover process between IEEE 802, 3GPP, and 3GPP2 networks. The standard defines a link layer SAP that offers a common interface for link layer functions which is independent of technology specifics. For example, the current IEEE 802.21 defines three primary services: Media Independent Event Services (MIES), Media Independent Command Services (MICS), and Media Independent Information Services (MIIS). The MIES may come from the MAC layer, PHY layer, or the MIH Function. The MIES may provide information corresponding to dynamic changes in link characteristics, link status, and link quality. MICS may refer to commands issued from upper to lower layers. The MICS may manage and control link behavior. MIIS may allow stations to collect information on homogeneous or heterogeneous networks existing within a geographical area. It should be appreciated that the characteristics and features of the current IEEE 802.21 standard are not intended to be limiting, and variations in these characteristics and features may be applicable to other embodiments.

The support of MIH may be established through implementation of an extension of MIHF that is capable of handling various wireless interfaces. The extension of the MIH Function as described herein may provide better monitoring (e.g., spectral sensing) and may cover other standards (e.g., Bluetooth) that may not be supported in MIH. Although in FIGS. 4A and 4B, the MIHF is shown only implemented on the client device 400, the MIHF may also be implemented within the proxy device 450 or any edge node of the network. It should be appreciated that other communication protocols may be implemented in other embodiments.

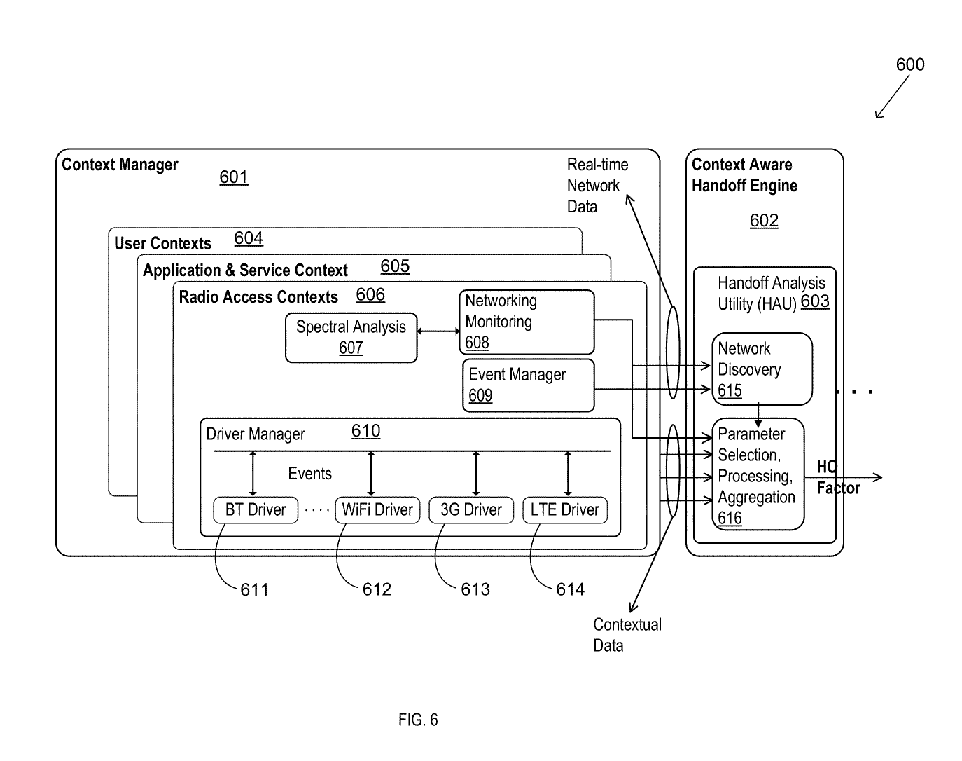

FIG. 6 illustrates an example block diagram of a context manager (CM) module 601 communicatively coupled to a CAHE module 602, according to certain embodiments. The CM module 601 may include MIH functionality and may be communicatively coupled to a HAU module 603 of the CAHE module 602. The CM module 601 is shown including user contexts 604, an application and service context 605, and radio access contexts 606. The radio access contexts 606 may include a spectral analysis module 607, a network monitoring module 608, an event manager module 609, and a driver manager module 610. The driver manager module 610 may include various drivers, such as a Bluetooth driver 611, a WiFi driver 612, a 3G driver 613, and an LTE driver 614. Other combinations of drivers may be implemented in other embodiments. The network monitoring module 608 may monitor and evaluate the wireless channel conditions to help with management of parameters related to link behavior and handovers. The network monitoring module 608 may collect information such as network performance, signal strength, link layer throughput, link quality, loss rate, and contention rate.

The HAU module 603 of the CAHE module 602 may include components such as a network discovery module 615 and parameter selection and processing aggregation module 616. The network discovery module 615 may collect filtered messages from the event manager module 609. The network discovery module 615 may also discover available points of attachment to neighboring networks. The network discovery module 615 may assist a mobile node to identify potential candidate PoAs for handover. The network discovery module 615 may also be present at a MIHF layer as an agent to discover neighbor networks. The network discovery module 615 may also be used to provide layer 3 movement detection. APs and BSs periodically send router advertisements (RAs), such as route solicitations, to inform the mobile nodes (MNs) about the network prefix. Similar to neighbor discovery in MIH, the network agent located in the MN may receive these RAs and determine if the message contains a new prefix and may inform a SSU module for a QoS aware handoff decision.

The parameter selection and processing aggregation module 616 may include, for example, the pre-processing module 506, the knowledge base module 507, the inference engine module 508, or combination thereof. In an embodiment, the parameter selection and processing aggregation module 616 may include the post-processing module 509.

The spectral analysis module 607 may be implemented in hardware or software running on the wireless drivers. The spectral analysis module 607 may facilitate “smart scanning” in order to speed up a handoff execution and enhancing QoS. Smart spectral scanning may enable some candidate channels to be ruled out due to early detection of interference. This may be beneficial to indoor environments where interference is important, such as indoor environments involving cellular (e.g., femtocell) and WiFi architectures. The spectral analysis module 607 may also enable interference classification, which may be used as important contextual information for vertical and horizontal handovers. Through analyzing the spectrum for unwanted devices, which are sources of interference, scanning may be speeded up to quickly rule out unwanted channels. This may also improve accuracy of scanning channel conditions and avoid handoff decisions that may not be beneficial, such as detrimental to performance.

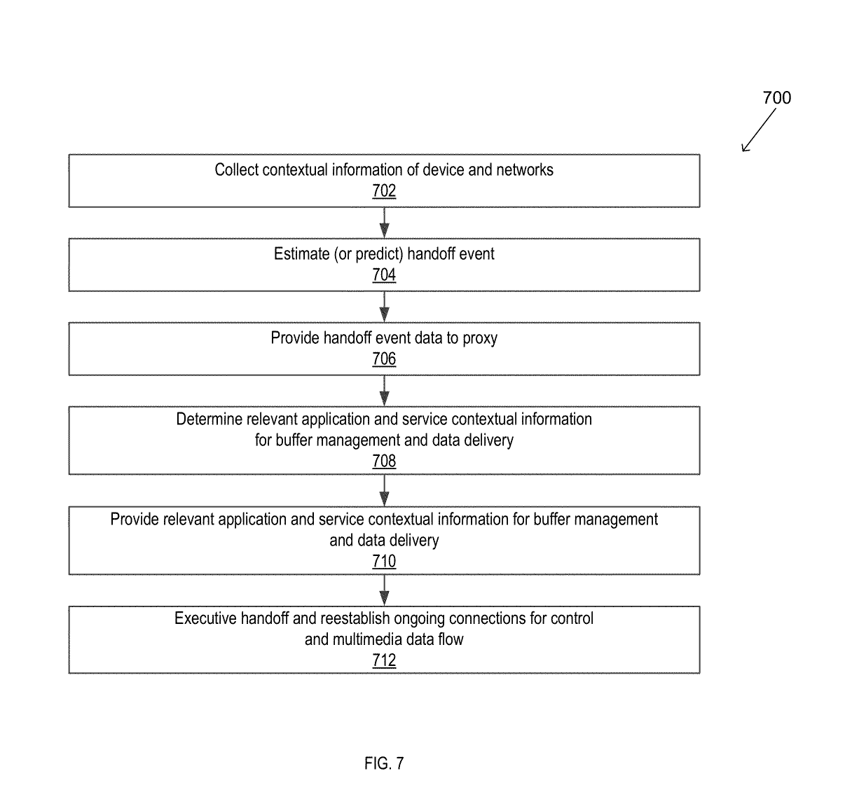

FIG. 7 illustrates a flowchart for an example method of a client side handover for a device-proxy configuration, according to certain embodiments. It should be appreciated that the discussion above for FIGS. 1-6 may also apply to the discussion of FIG. 7. For the sake of brevity and clarity, every feature and function applicable to FIG. 7 is not repeated here.

At block 702 of method 700, contextual information of the client device and networks may be collected (or monitored). The contextual information may include device level contextual information, application level contextual information, network level contextual information, and user level contextual information. For example, in an embodiment, the contextual information may include information as to a device state or available radio access channels, such as RSSI, interference signatures, spectrum occupancy, etc. In certain embodiments, block 702 may be performed by the HAU module 406 of FIG. 4A. In some instances, the HAU module 406 may collect contextual information that was originally obtained by the CM module 404 of FIG. 4A.

At block 704, handoff events may be estimated (or predicted). The handoff events may be associated with a specific handoff between PoAs. The estimation may be based on the contextual information monitored and collected at block 702. At block 706, data identifying the handoff event (or handoff event data) may be provided (or communicated) to a proxy device. In certain embodiments, providing the handoff event data may include identifying and transmitting the handoff event data to the proxy device. The proxy device may, for instance, be a service gateway or a network edge device in an ecosystem. In certain embodiments, blocks 704 and 706 may be performed by the HAU module 406 of FIG. 4A.

At block 708, relevant application and service contextual information associated with buffer management and data delivery may be determined. For example, the contextual information may include application related profiles, such as device characteristics and capabilities, user RAN preferences, service level specifications, etc. The contextual information may also include the applications QoS parameters, such as maximum allowed jitter, delay, and packet loss. At block 710, the contextual information associated with buffer management and data delivery may be provided (or communicated) to the proxy device. In certain embodiments, providing the contextual information associated with buffer management and data delivery may include identifying and transmitting the contextual information to the proxy device. In certain embodiments, blocks 708 and 710 may be performed by the SSU module 407 of FIG. 4A. In some instances, the SSU module 407 may collect some contextual information that was originally obtained by the CM module 404 of FIG. 4A.

At block 712, handoff may be executed and ongoing connections reestablished for control and multimedia data flow. Client readdressing and component rebinding may be provided for various types of handoffs, such as macro handoffs, intra domain handoffs, and global handoffs, such as described herein. In certain embodiments, block 712 may be performed by the SRU module 408 of FIG. 4A.

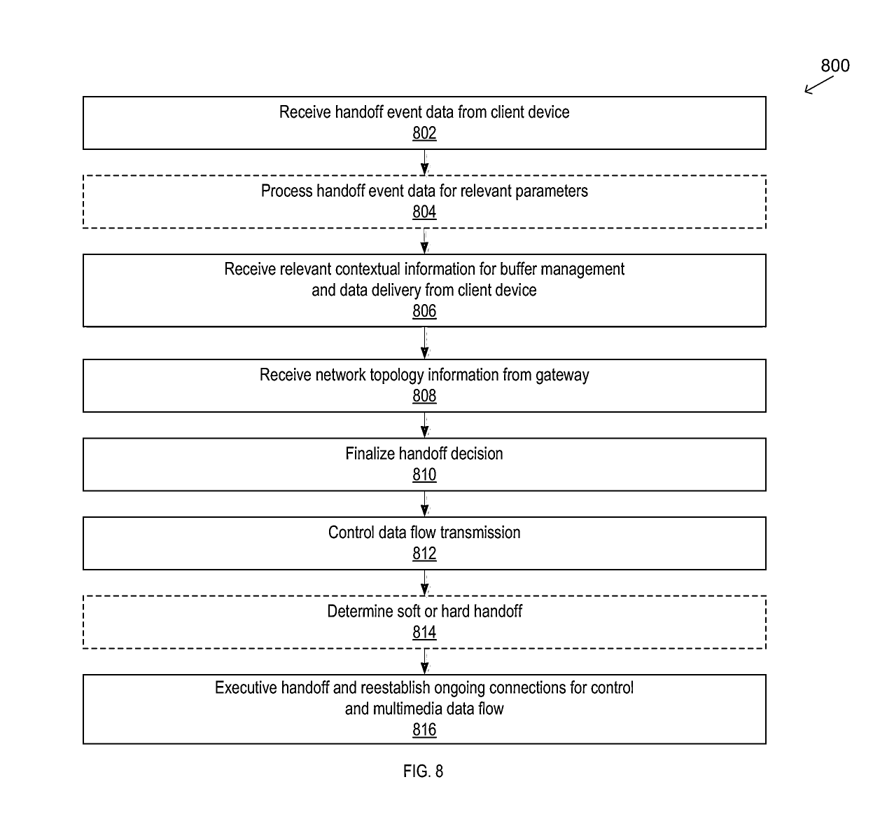

FIG. 8 illustrates a flowchart for an example method of a proxy side handover for a device-proxy configuration, according to certain embodiments. It should be appreciated that the discussion above for FIGS. 1-6 may also apply to the discussion of FIG. 8. For the sake of brevity and clarity, every feature and function applicable to FIG. 8 is not repeated here.

At block 802 of method 800, handoff event data is received from a client device. At block 804, the handoff event data, which may include relevant handoff parameters, may be processed. Example handoff event data may include a target AP or BS information (e.g., a corresponding MAC address), a type of handoff (e.g., vertical or horizontal, soft or hard, etc.), information regarding a minimum time for a handoff to occur, data link handoff latency, HO factor, etc. In an embodiment, blocks 802 and 804 may be performed by the HAU module 456 of FIG. 4B. In an embodiment, block 804 may be optional or not necessarily occur.

At block 806, relevant contextual information for buffer management and data delivery may be received from the client device. For example, the contextual information may include application related profiles, such as device characteristics and capabilities, user RAN preferences, service level specifications, etc. The contextual information may also include the applications QoS parameters, such as maximum allowed jitter, delay, and packet loss. In certain embodiments, block 806 may be performed by the SSU module 457 of FIG. 4B. At block 808, network topology information may be received, such as from a service gateway for instance. In certain embodiments, block 808 may be performed by the service gateway manager 452 of FIG. 4B. At block 810, a determination as to a final handoff decision is made. At block 812, data flow transmission may be controlled. At block 814, a determination may be made as to a type of handoff, such as whether the handoff should be soft or hard. In an embodiment, block 814 may be optional or not necessarily occur. In certain embodiments, blocks 810 through 814 may be performed by the SSU module 457 of FIG. 4B.

At block 816, the handoff is executed and ongoing connections reestablished for control and multimedia data flow with the client device. In certain embodiments, block 816 may be performed by the SRU module 458 of FIG. 4B.

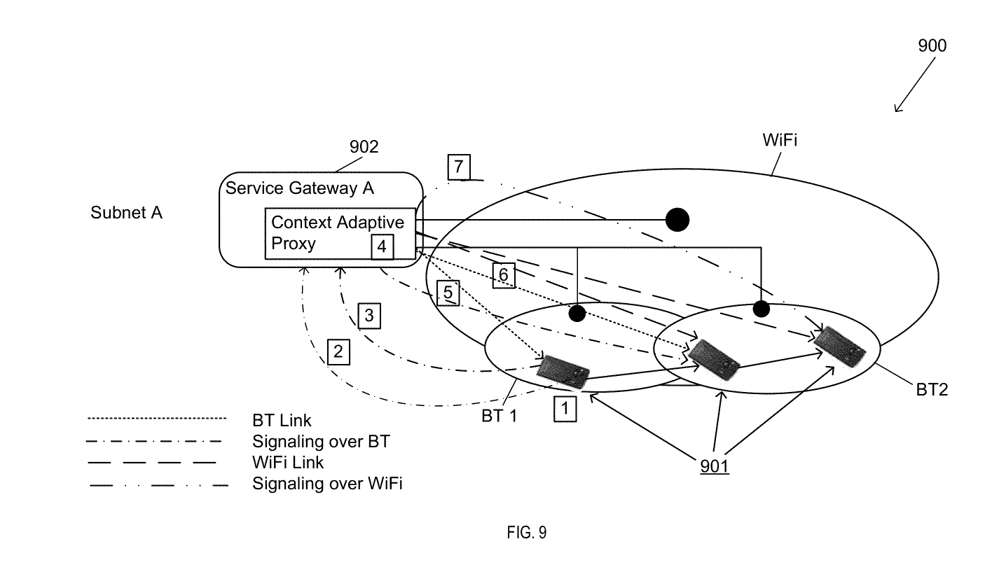

FIG. 9 illustrates a diagram of an example Bluetooth-WiFi handoff for a client device 901 in a heterogeneous network 900, according to certain embodiments. The heterogeneous network 900 is shown including a service gateway 902 having a context adaptive proxy device and a first Bluetooth access point “BT1”, a second Bluetooth access point “BT2”, and a WiFi access point “WiFi”. The client device 901 is shown at three different times during the handoff process. The connection between the context adaptive proxy device of the service gateway 902 and the client device 901 is shown by solid arrows in FIG. 9. The client device 901 (e.g., a context adaptive device) is shown initially connected to the first Bluetooth access point BT1. The reference points 1 through 7 are shown on the diagram and represent various actions that are performed during the handoff. The example sequence of actions is indicated by dotted arrows in FIG. 9. The specific actions described at the reference points are exemplary and are not intended to be limiting.

At reference point 1, a HAU module in a client device 901 may predict a horizontal handoff. At reference point 2, the HAU module in the client device 901 may notify a SSU module in a proxy device with a message identifying the MAC address of a next BT AP and other information, such as handoff latency, handoff type, etc. At reference point 3, the HAU module in the client device 901 may notify the SSU module in the proxy device with a message identifying the possibility of a vertical handoff to WiFi. At reference point 4, the SSU module in the proxy device may analyze the data received from the HAU module in the client device 901, along with network topology information and service requirements. The SSU module may determine that a horizontal handoff (e.g., to the second Bluetooth access point BT2) does not meet the application's tolerable delay, and that a vertical handoff to the WiFi access point does meet the delay while meeting an energy consumption requirement of the client device 901. At reference point 5, based on analysis of VHO latency and a horizontal handoff prediction time, the SSU module on the proxy device may decide on a soft handoff to WiFi. The SSU module may communicate the decision to the client device 901. The SSU module on the proxy device may activate another service path for WiFi towards the client device 901. The SSU module may order the client device 901 to split the mult-media flow. New end points for the proxy-client data flow may be established by the SRU module on the proxy device. At reference point 6, the SSU module on the proxy device may initiate duplication of outgoing data while the SSU module on the client device 901 may remove possible duplicates from a rendering buffer. At reference point 7, WiFi may become a default interface for the service. In certain embodiments, the steps performed at reference points 1-7 may be performed by the client device 400 and the proxy device 401 of FIGS. 4A and 4B, respectively.

The VHO process may include three phases. In a first phase (e.g., the network monitoring phase), contextual information may be collected. In a second phase (e.g., the network discovery phase) the contextual information may be processed. In a third phase, handoff execution may occur. The SSU module and the SRU module on both the client device and the proxy device may perform actions for handoff execution, handoff management, and mobility management. In various embodiments, the portioning and details of tasks may vary between client device and proxy device. The VHO may be committed during the handoff execution phase of a VHO. Once the contextual information is collected in phase one and processed in phase two by selecting the network candidate, a network binding update will be triggered for the handoff execution phase. The handoff execution phase may focus on factors such as control, security, session and mobility, among other issues, in order to perform a seamless handover.

With regard to handoff management, a mobile controlled VHO may be initiated and controlled by a client device, such as a mobile device. Mobile control may be based on user preferences. In certain embodiments, the VHO may be network assisted. In such case, for example, the VHO may be initiated by the mobile device and assisted by the network making use of the information services, such as those related to the MIIS). In certain embodiments, the VHO may be mobile assisted. For instance, the VHO may be initiated by the network but assisted by the mobile device. Mobility management may be a factor in achieving a seamless handover. In IP based networks, standard protocols designed for mobility may enable a session to be maintained alive when targeting a seamless handover.

In another embodiment, device middleware may perform a dynamic combination instead of a hard switch between networks. For example, in one situation a device may have access to both WiFi and cellular networks. The device middleware may determine that instead of performing a hard handover switch from WiFi and cellular (e.g., resulting in offloading all data packets to one network), it may be more beneficial to perform a softer handover and dynamically switch sending data packets on WiFi and cellular networks based on conditions and context. In this way, a device controlled IP flow mobility with seamless switching transparent to the user may be achieved.

### Additional Example Embodiments

Computer implemented methods, systems, and computer readable media provided herein may identify contextual information associated with buffer management and data delivery for a handoff between radio access technology points of attachment for a client device. Whether to perform the handoff based on the contextual information and quality of experience (QoE) parameters for an application on the client device may be determined. The handoff may be executed based on the contextual information associated with buffer management and data delivery. An ongoing connection may be reestablished for control and multimedia data flow for the client device.

In an embodiment, a handoff event associated with the handoff may be estimated.

In an embodiment, data identifying the handoff event may be communicated to a proxy device. The contextual information associated with buffer management and data delivery may be communicated to the proxy device.

In an embodiment, the contextual information may include at least one of application related profiles and service related information.

In an embodiment, the contextual information may include QoS parameters for an application on the client device.

In an embodiment, data identifying a handoff event may be received from the client device. The handoff event may be associated with the handoff. The contextual information associated with buffer management and data delivery may be received from the client device.

In an embodiment, a determination to execute the handoff may be decided by at least one of the client device or a proxy device.

In an embodiment, data flow transmission may be controlled. A type of handoff may be determined.

In an embodiment, network topology information may be received from a gateway device.

Hardware Implementation

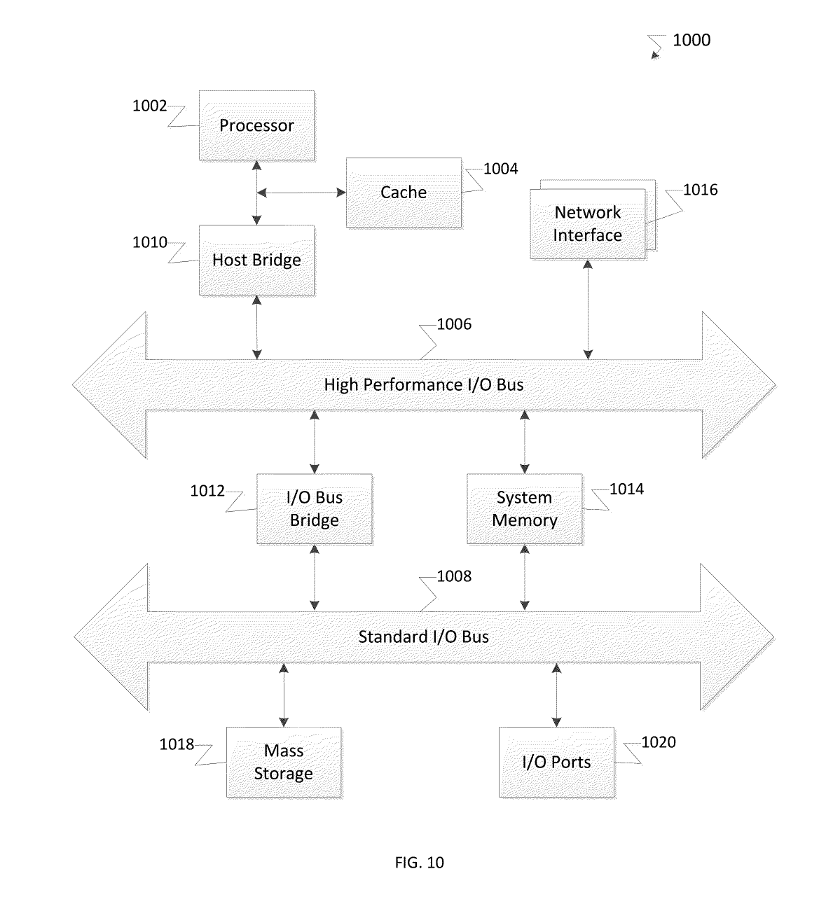

The foregoing processes and features can be implemented by a wide variety of machine and computer system architectures and in a wide variety of network and computing environments. FIG. 10 illustrates an example of a computer system 1000 that may be used to implement one or more of the embodiments described herein in accordance with certain embodiments of the invention. The computer system 1000 includes sets of instructions for causing the computer system 1000 to perform the processes and features discussed herein. The computer system 1000 may be connected (e.g., networked) to other machines. In a networked deployment, the computer system 1000 may operate in the capacity of a server machine or a client machine in a client-server network environment, or as a peer machine in a peer-to-peer (or distributed) network environment. In certain embodiments of the invention, the computer system 1000 may be a component of the networking system described herein. In certain embodiments of the present disclosure, the computer system 1000 may be one server among many that constitutes all or part of a networking system.

In certain embodiments, the computer system 1000 may be implemented as the client device 102 of FIG. 1 or the client device 400 of FIG. 4A. In certain embodiments, the computer system 400 may be implemented as the proxy device 104 of FIG. 1 or the proxy device 450 of FIG. 4B.

The computer system 1000 includes a processor 1002, a cache 1004, and one or more executable modules and drivers, stored on a computer-readable medium, directed to the processes and features described herein. Additionally, the computer system 1000 may include a high performance input/output (I/O) bus 1006 or a standard I/O bus 1008. A host bridge 1010 couples processor 1002 to high performance I/O bus 1006, whereas I/O bus bridge 1012 couples the two buses 1006 and 1008 to each other. A system memory 1014 and one or more network interfaces 1016 couple to high performance I/O bus 1006. The computer system 1000 may further include video memory and a display device coupled to the video memory (not shown). Mass storage 1018 and I/O ports 1020 couple to the standard I/O bus 1008. The computer system 1000 may optionally include a keyboard and pointing device, a display device, or other input/output devices (not shown) coupled to the standard I/O bus 1008. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 1000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 1000 are described in greater detail below. In particular, the network interface 1016 provides communication between the computer system 1000 and any of a wide range of networks, such as an Ethernet (e.g., IEEE 802.3) network, a backplane, etc. The mass storage 1018 provides permanent storage for the data and programming instructions to perform the above-described processes and features implemented by the respective computing systems identified above, whereas the system memory 1014 (e.g., DRAM) provides temporary storage for the data and programming instructions when executed by the processor 1002. The I/O ports 1020 may be one or more serial and/or parallel communication ports that provide communication between additional peripheral devices, which may be coupled to the computer system 1000.

The computer system 1000 may include a variety of system architectures, and various components of the computer system 1000 may be rearranged. For example, the cache 1004 may be on-chip with processor 1002. Alternatively, the cache 1004 and the processor 1002 may be packed together as a “processor module”, with processor 1002 being referred to as the “processor core”. Furthermore, certain embodiments of the invention may neither require nor include all of the above components. For example, peripheral devices coupled to the standard I/O bus 1008 may couple to the high performance I/O bus 1006. In addition, in certain embodiments, only a single bus may exist, with the components of the computer system 1000 being coupled to the single bus. Furthermore, the computer system 1000 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 1000 that, when read and executed by one or more processors, cause the computer system 1000 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 1000, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 1002. Initially, the series of instructions may be stored on a storage device, such as the mass storage 1018. However, the series of instructions can be stored on any suitable computer readable storage medium. Furthermore, the series of instructions need not be stored locally, and could be received from a remote storage device, such as a server on a network, via the network interface 1016. The instructions are copied from the storage device, such as the mass storage 1018, into the system memory 1014 and then accessed and executed by the processor 1002. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 1000 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “certain embodiments”, “other embodiments”, “one series of embodiments”, “certain embodiments”, “various embodiments”, or the like means that a particular feature, design, structure, or characteristic described in connection with the embodiment is included in at least one embodiment of the disclosure. The appearances of, for example, the phrase “in one embodiment” or “in certain embodiments” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in certain embodiments, but also variously omitted in other embodiments. Similarly, various features are described that may be preferences or requirements for certain embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed:

1. A system comprising:
at least one processor; and
a memory storing instructions configured to instruct the at least one processor to:
identify contextual information associated with buffer management and data delivery for a handoff between radio access technology points of attachment for a client device;
determine whether to perform the handoff based on the contextual information and quality of experience (QoE) parameters for an application on the client device;
execute the handoff based on the contextual information associated with buffer management and data delivery; and
reestablish an ongoing connection for control and multimedia data flow for the client device.

2. The system of claim 1, wherein the memory storing instructions are further configured to instruct the at least one processor to:
estimate a handoff event associated with the handoff.

3. The system of claim 2, wherein the memory storing instructions are further configured to instruct the at least one processor to:
communicate data identifying the handoff event to a proxy device; and
communicate the contextual information associated with buffer management and data delivery to the proxy device.

4. The system of claim 1, wherein the contextual information includes at least one of application related profiles and service related information.

5. The system of claim 1, wherein the contextual information includes QoS parameters for an application on the client device.

6. The system of claim 1, wherein the memory storing instructions are further configured to instruct the at least one processor to:
receive data identifying a handoff event from the client device, the handoff event associated with the handoff; and
receive the contextual information associated with buffer management and data delivery from the client device.

7. The system of claim 1, wherein a determination to execute the handoff is decided by at least one of the client device or a proxy device.

8. The system of claim 1, wherein the memory storing instructions are further configured to instruct the at least one processor to:
control data flow transmission; and
determine a type of handoff.

9. The system of claim 1, wherein the memory storing instructions are further configured to instruct the at least one processor to:
receive network topology information from a gateway device.

10. A method, comprising:
identifying, by a computer system, contextual information associated with buffer management and data delivery for a handoff between radio access technology points of attachment for a client device;
determining, by the computer system, whether to perform the handoff based on the contextual information and quality of experience (QoE) parameters for an application on the client device;
executing, by the computer system, the handoff based on the contextual information associated with buffer management and data delivery; and
reestablishing, by the computer system, an ongoing connection for control and multimedia data flow for the client device.

11. The method of claim 10, further comprising:
estimating a handoff event, the handoff event associated with the handoff.

12. The method of claim 11, further comprising:
communicating data identifying the handoff event to a proxy device; and
communicating the contextual information associated with buffer management and data delivery to the proxy device.

13. The method of claim 10, wherein the contextual information includes application related profiles and service related information.

14. The method of claim 10, further comprising:
receiving data identifying a handoff event from the client device, the handoff event associated with the handoff; and
receiving the contextual information associated with buffer management and data delivery from the client device.

15. The method of claim 10, further comprising:
receiving network topology information from a gateway device.

16. A non-transitory computer storage medium storing computer-executable instructions that, when executed, cause a computer system to perform a computer-implemented method comprising:
identifying contextual information associated with buffer management and data delivery for a handoff between radio access technology points of attachment for a client device;
determining whether to perform the handoff based on the contextual information and quality of experience (QoE) parameters for an application on the client device;
executing the handoff based on the contextual information associated with buffer management and data delivery; and
reestablishing an ongoing connection for control and multimedia data flow for the client device.

17. The non-transitory computer storage medium of claim 16, further comprising:
estimating a handoff event, the handoff event associated with the handoff.

18. The non-transitory computer storage medium of claim 17, further comprising:
communicating data identifying the handoff event to a proxy device; and
communicating the contextual information associated with buffer management and data delivery to the proxy device.

19. The non-transitory computer storage medium of claim 16, further comprising:
receiving data identifying a handoff event from the client device, the handoff event associated with the handoff; and
receiving the contextual information associated with buffer management and data delivery from the client device.

20. The non-transitory computer storage medium of claim 16, further comprising:
receiving network topology information from a gateway device.
